(19) United States
(12) Patent Application Publication
(10) Pub. No.: US 2015/0124477 A1
(43) Pub. Date: May 7, 2015

(54) LIGHT-GUIDING TOOL SHANK, HIGH LIGHT-GUIDE TOOL SHANK, AND LIGHT-EMITTING FASTENING TOOL

(71) Applicant: TING-JUI WANG, New Taipei City (TW)

(72) Inventor: TING-JUI WANG, New Taipei City (TW)

(21) Appl. No.: 14/495,705

(22) Filed: Sep. 24, 2014

(30) Foreign Application Priority Data
Nov. 4, 2013 (TW) 102140006

(51) Int. Cl. B25B 23/18; F21V 8/00; F21V 33/00; B25B 15/00; B25D 1/00

(52) U.S. Cl. CPC B25B 23/18; B25B 15/005; B25B 15/007; B25B 15/008; B25D 1/00; F21V 33/0084; G02B 6/0008; F21Y 2101/02
USPC 362/577; 362/120

(57) ABSTRACT

A light-guiding tool shank, a handle unit, a light-emitting element and a power allocation unit are assembled together to form a light-emitting fastening tool. The light-guiding tool shank includes a shank body, a light-guiding portion and a fastener fixing head. The shank body has a first and a second end; the light-guiding portion is formed in the shank body to locate between the first and the second end of the shank body; and the fastener fixing head is located at the first end of the shank body and defines a light projecting hole that is communicable with the light-guiding portion. With these arrangements, the light-emitting fastening tool enables a user to quickly sort out a desired fastener and align the same with a predetermined fastener fixing position even in a dark working environment or in the night, so that the fastener can be fixed in increased working efficiency.

### CROSS-REFERENCE TO RELATED APPLICATION

This non-provisional application claims priority under 35 U.S.C. §119(a) on Patent Application No(s).102140006 filed in Taiwan, R.O.C. on Nov. 4, 2013, the entire contents of which are hereby incorporated by reference.

### FIELD OF THE INVENTION

The present invention relates to a fastening tool, and more particularly to a light-emitting fastening tool that enables a user to quickly sort out a desired fastener and align the same with a predetermined fastener fixing position even in a dark working environment or in the night, so that the fastener can be fixed in increased working efficiency.

### BACKGROUND OF THE INVENTION

In a very dark working environment, it is uneasy for a user to quickly sort out a desired fastener and align it with a predetermined fastener fixing position, so that the fastener could not be accurately fixed.

Under the above circumstances, another user's help is usually needed to illuminate the predetermined fastener fixing position, so that the first user can accurately fix the fastener. It is of course inconvenient to do so.

It is therefore tried by the inventor to develop a fastening tool that enables a user to quickly sort out a desired fastener and align the same with a predetermined fastener fixing position even in a dark working environment or in the night, so that the fastener can be fixed in high working efficiency.

### SUMMARY OF THE INVENTION

To solve the above problems, a primary object of the present invention is to provide a light-guiding tool shank for assembling with a handle unit, a light-emitting element and a power allocation unit to form a light-emitting fastening tool. With the light-emitting fastening tool, a user is enabled to quickly sort out a desired fastener and align the same with a predetermined fastener fixing position even in a dark working environment or in the night, so that the fastener can be fixed in increased working efficiency. With the light guiding function thereof, the light-emitting fastening tool can also be used in a bright working environment to help the user more accurately align the fastener with the predetermined fastener fixing position to increase the working efficiency.

To achieve the above and other objects, the present invention provides a light-guiding tool shank, which can be assembled with a handle unit, a light-emitting element and a power allocation unit to form a light-emitting fastening tool. The light-guiding tool shank includes a shank body, a light-guiding portion and a fastener fixing head.

The shank body has a first end and an opposite second end; the light-guiding portion is formed in the shank body to locate between the first and the second end of the shank body; and the a fastener fixing head is located at the first end of the shank body and defines a light projecting hole that is communicable with the light-guiding portion.

According to an embodiment of the light-guiding tool shank, the shank body thereof is provided with at least one light-guiding hole, which is extended through a peripheral wall of the shank body and communicable with the light-guiding portion.

According to the present invention, the fastener fixing head of the light-guiding tool shank can be a screwdriver's head or a hammer's head.

According to the present invention, in the case the fastener fixing head of the light-guiding tool shank is a screwdriver's head, it can be a slot head, a cross-recess head, a hexagon head, a star head, or a combined star and slot head.

According to the present invention, the light-guiding tool shank can be a straight bar or a bent bar.

According to an embodiment of the light-guiding tool shank, the light-guiding portion thereof is communicable with the first and the second end.

To achieve the above and other objects, the present invention also provides a high light-guiding tool shank, which includes a light-guiding tool shank described above and a light-guiding body disposed in the light-guiding portion of the light-guiding tool shank.

According to an embodiment of the high light-guiding tool shank, the shank body thereof is provided on an inner surface of a peripheral wall thereof with at least one of a plurality of protrusions, a plurality of recesses, a plurality of screw threads and a plurality of embossed areas; and the protrusions, the recesses, the screw threads and the embossed areas are located within the light-guiding portion for holding the light-guiding body in place in the shank body.

In the high light-guiding tool shank, the light-guiding body has a shape corresponding to that of the light-guiding portion.

In the high light-guiding tool shank, the light-guiding body can be made of an optic fiber, a fiber, plastics, glass, quartz, acrylic, rubber or silicone.

In the high light-guiding tool shank, the light-guiding body can be held in the light-guiding portion by way of hooking, gluing, expansion fitting, snap fitting, thermal bonding or insert molding.

To achieve the above and other objects, the present invention also provides a light-emitting fastening tool for fixing a fastener in place. In one embodiment thereof, the light-emitting fastening tool includes a handle unit, a light-guiding tool shank, a light-emitting element, and a power allocation unit.

In the light-emitting fastening tool, the light-guiding tool shank can be the above described light-guiding tool shank, and the shank body thereof is connected at the second end to the handle unit; the light-emitting element is disposed in the light-guiding portion of the light-guiding tool shank or the handle unit for emitting a light beam, and the light beam sequentially passes through the light-guiding portion and the light projecting hole; and the power allocation unit is arranged in the handle unit or the light-guiding tool shank and is electrically connected to the light-emitting element.

According to an embodiment thereof, the light-emitting fastening tool further includes a switch unit arranged on the handle unit or the shank body, and is electrically connected to the light-emitting element.

According to the light-emitting fastening tool, the shank body is inserted into the handle unit.

According to the light-emitting fastening tool, the light-emitting element is a light-emitting diode (LED).

According to an embodiment of the light-emitting fastening tool, the handle unit and the shank body are integrally formed with each other.

To achieve the above and other objects, in another embodiment of the light-emitting fastening tool for fixing a fastener in place according to the present invention, it includes a handle unit, a high light-guiding tool shank, a light-emitting element, and a power allocation unit.

The high light-guiding tool shank can be the above-described high light-guiding tool shank, of which the shank body is connected at the second end to the handle unit. The light-emitting element is disposed in the light-guiding portion of the high light-guiding tool shank or the handle unit for emitting a light beam, and the light beam sequentially passes through the light-guiding portion and the light projecting hole. The power allocation unit is arranged in the handle unit or the high light-guiding tool shank, and is electrically connected to the light-emitting element.

According to the above embodiment of the light-emitting fastening tool, it can further include a switch unit that is arranged on the handle unit or the shank body and electrically connected to the light-emitting element.

According to the above embodiment of the light-emitting fastening tool, the shank body is inserted into the handle unit.

According to the above embodiment of the light-emitting fastening tool, the light-emitting element is a light-emitting diode (LED).

According to an embodiment of the above light-emitting fastening tool, the handle unit and the shank body are integrally formed with each other.

In summary, both of the light-guiding tool shank and the high light-guiding tool shank according to the present invention can be assembled with the handle unit, the light-emitting element and the power allocation unit to form the light-emitting fastening tool of the present invention. And, with the light-emitting fastening tool, a user is enabled to quickly sort out a desired fastener and align the same with a predetermined fastener fixing position even in a dark working environment or in the night, so that the fastener can be fixed in increased working efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a first embodiment of a light-guiding tool shank according to the present invention;

FIGS. 2A to 2E are bottom views showing various head types for a fastener fixing head of the light-guiding tool shank of the present invention when the fastener fixing head is configured as a screwdriver's head;

FIG. 3 is a sectional view of a second embodiment of the light-guiding tool shank according to the present invention;

FIG. 4 is a sectional view of a first embodiment of a high light-guiding tool shank according to the present invention;

FIG. 5 is a sectional view of a second embodiment of the high light-guiding tool shank according to the present invention;

FIG. 6 is a sectional view showing a first embodiment of a light-emitting fastening tool according to the present invention and the use thereof;

FIG. 7 is a sectional view showing a second embodiment of the light-emitting fastening tool according to the present invention and the use thereof;

FIG. 8 is a sectional view showing a third embodiment of the light-emitting fastening tool according to the present invention; and

FIG. 9 is a sectional view showing a fourth embodiment of the light-emitting fastening tool according to the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

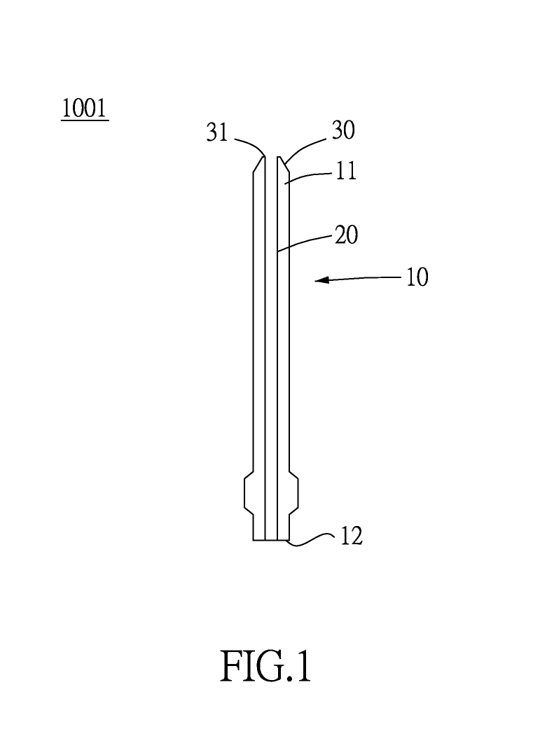

Please refer to FIG. 1 that is a sectional view of a first embodiment of a light-guiding tool shank according to the present invention. In the first embodiment thereof, the light-guiding tool shank is generally denoted by reference numeral 1001. The light-guiding tool shank 1001 can be assembled to a handle unit (not shown), a light-emitting element (not shown) and a power allocation unit (not shown) to form a light-emitting fastening tool (not shown). The light-guiding tool shank 1001 includes a shank body 10, a light-guiding portion 20, and a fastener fixing head 30.

The shank body 10 has a first end 11 and an opposite second end 12. The light-guiding portion 20 is formed in the shank body 10 to locate between and communicate with the first and the second end 11, 12 of the shank body 10. The fastener fixing head 30 is located at the first end 11 of the shank body 10 and defines a centered light projecting hole 31, which is communicable with the light-guiding portion 20. It is understood the light projecting hole 31 can be otherwise provided at any other suitable position on the fastener fixing head 30. Further, in the first embodiment, the shank body 10 is configured as a straight bar and the light-guiding portion 20 is configured as a straight passage in the shank body 10.

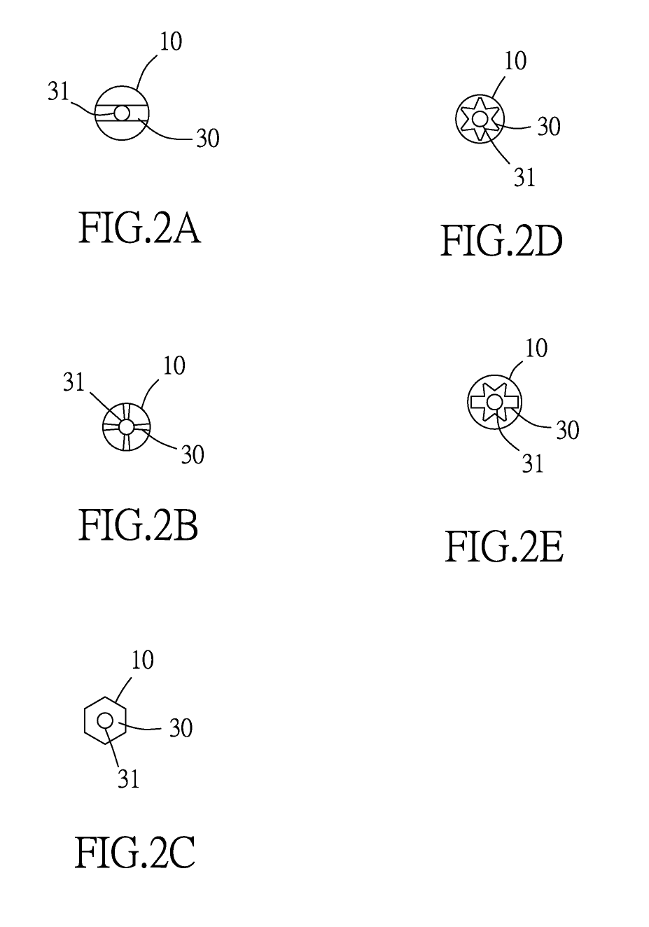

As shown in FIG. 1, in the light-guiding tool shank 1001, the fastener fixing head 30 located at the first end 11 of the shank body 10 is configured as a screwdriver's head. In this case, the screwdriver's head can be a slot head, as shown in FIG. 2A; a cross-recess head, as shown in FIG. 2B; a hexagon head, as shown in FIG. 2C; a star head, as shown in FIG. 2D; a combined star and slot head, as shown in FIG. 2E; or any other suitable head type.

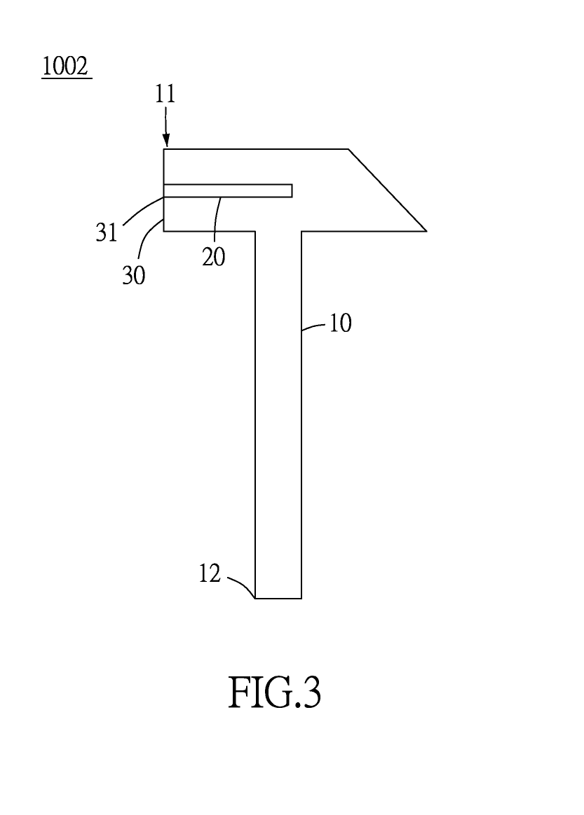

FIG. 3 is a sectional view of a second embodiment of the light-guiding tool shank according to the present invention, which is generally denoted by reference numeral 1002 herein. The light-guiding tool shank 1002 is generally similar to the light-guiding tool shank 1001 in design, except that the light-guiding tool shank 1002 has a shank body 10 in the form of a bent bar, and a light-guiding portion 20 that communicates with the first end 11 but not the second end 12 of the shank body 10. In the second embodiment, the fastener fixing head 30 is configured as a hammer's head.

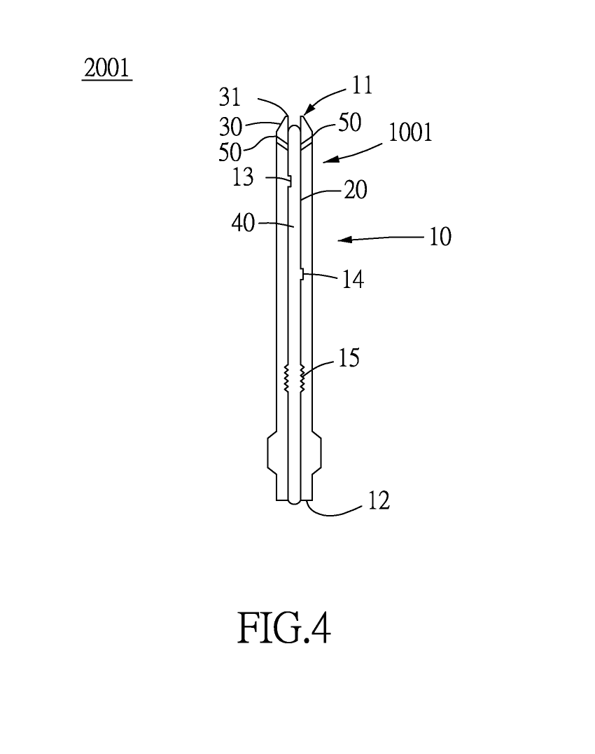

Please refer to FIG. 4 that is a sectional view of a first embodiment of a high light-guiding tool shank according to the present invention. In the first embodiment thereof, the high light-guiding tool shank is generally denoted by reference numeral 2001. The high light-guiding tool shank 2001 includes the above-described light-guiding tool shank 1001 and a light-guiding body 40. The light-guiding body 40 is disposed in the light-guiding portion 20 of the light-guiding tool shank 1001, and has a shape corresponding to that of the light-guiding portion 20. The light-guiding body 40 can be made of different materials, including but not limited to an optic fiber, a fiber, plastics, glass, quartz, acrylic, rubber and silicone.

The light-guiding tool shank 1001 for the high light-guiding tool shank 2001 further includes at least one light-guiding hole 50, which is provided on and extended through a peripheral wall of the shank body 10 to communicate with the light-guiding portion 20. More specifically, the light-guiding hole 50 is slantingly extended from the light-guiding portion 20 through the peripheral wall of the shank body 10 toward the first end 11 of the shank body 10.

Please refer to FIG. 4 again. The shank body 10 is provided on an inner surface of the peripheral wall with a plurality of protrusions 13, recesses 14 and screw threads 15. Alternatively, the shank body 10 can be further provided on the inner surface of the peripheral wall with embossed areas (not shown). The protrusions 13, the recesses 14 and the screw threads 15 are located within the light-guiding portion 20 for holding the light-guiding body 40 in place in the shank body 10. However, it is understood the protrusions 13, the recesses 14, the screw threads 15 or the embossed areas are not necessarily to exist at the same time. That is, the shank body 10 can be formed with at least one of the protrusions 13, the recesses 15, the screw threads 15 and the embossed areas according to actual need in use. Moreover, the light-guiding body 40 can be held in the light-guiding portion 20 in different ways, such as hooking, gluing, expansion fitting, snap fitting, thermal bonding, or insert molding. In the case of gluing, an adhesive is applied on the light-guiding portion 20 or the light-guiding body 40.

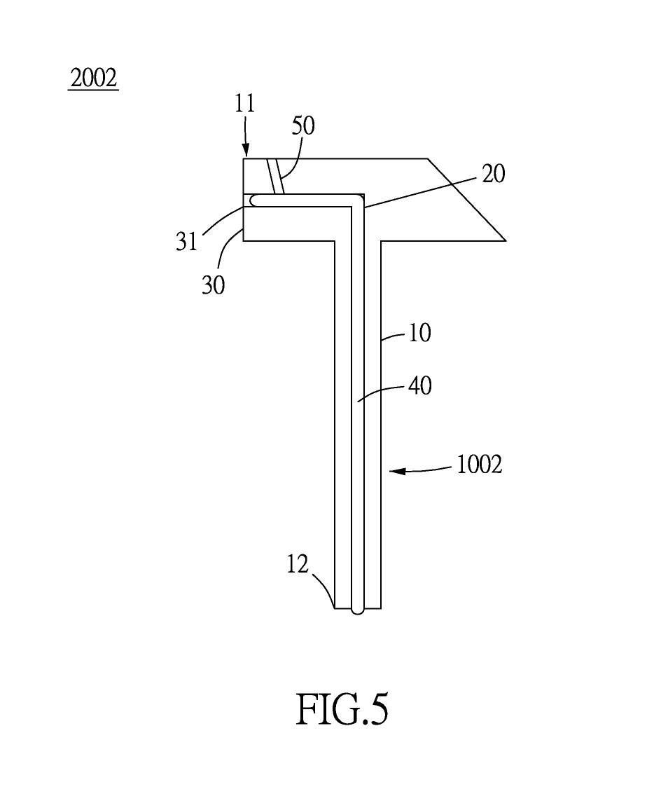

FIG. 5 is a sectional view of a second embodiment of the high light-guiding tool shank according to the present invention, which is generally denoted by reference numeral 2002 herein. The high light-guiding tool shank 2002 is generally similar to the high light-guiding tool shank 2001 in design, except that the high light-guiding tool shank 2002 has a shank body 10 in the form of a bent bar, a light-guiding portion 20 in the form of a bent passage communicating the first end 11 with the second end 12 of the shank body 10, and a fastener fixing head 30 configured as a hammer's head.

In the high light-guiding tool shank 2002, since the shank body 10 is a bent bar and the light-guiding portion 20 is a bent passage and the light-guiding body 40 has a shape corresponding to that of the light-guiding portion 20, the light-guiding body 40 in the high light-guiding tool shank 2002 is a bent light-guiding body.

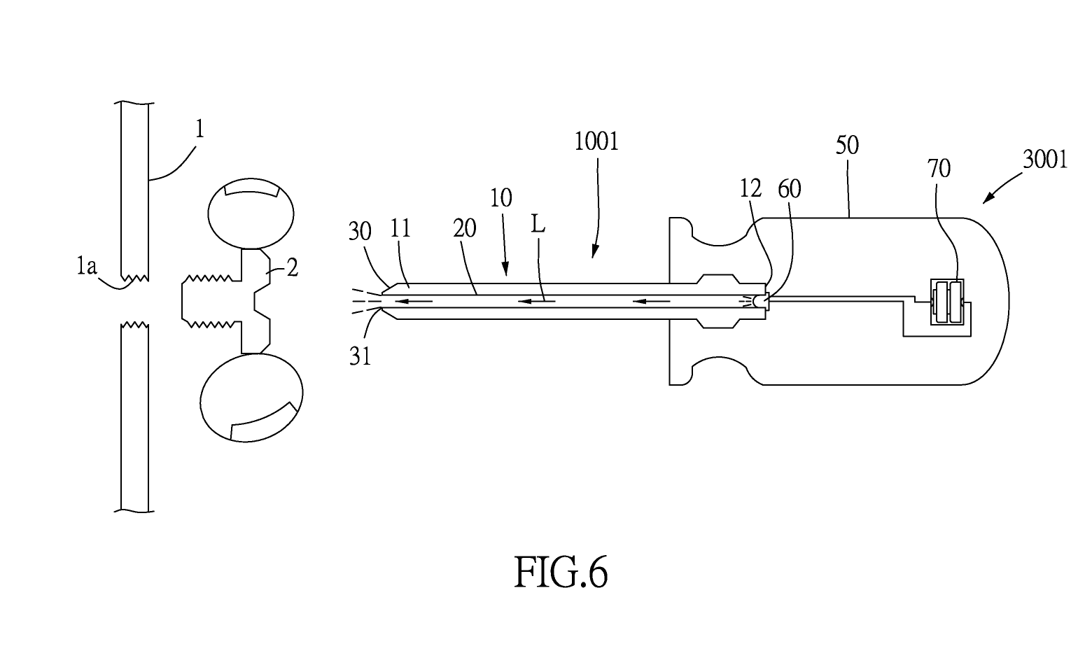

Please refer to FIG. 6 that is a sectional view showing the structure and the use of a first embodiment of a light-emitting fastening tool according to the present invention, which is generally denoted by reference numeral 3001 herein. As shown, the light-emitting fastening tool 3001 includes a handle unit 60, the above-described light-guiding tool shank 1001, a light-emitting element 70, and a power allocation unit 80.

The shank body 10 of the light-guiding tool shank 1001 is connected at the second end 12 to the handle unit 60.

The light-emitting element 70 is disposed in the light-guiding portion 20 of the light-guiding tool shank 1001 and is capable of emitting a light beam L, which sequentially passes through the light-guiding portion 20 and the light projecting hole 31. According to the present invention, the light-emitting element 70 is preferable a light-emitting diode (LED).

The power allocation unit 80 is arranged in the handle unit 60 and is electrically connected to the light-emitting element 70 for supplying power to the latter. The power allocation unit 80 can be a battery holder, into which a user can mount batteries or rechargeable batteries prior to or after using the light-emitting fastening tool 3001, depending on actual need in use. Alternatively, the power allocation unit 80 can be a solar battery that converts solar energy into electric energy and supplies the latter to the light-emitting element 70. Further, the power allocation unit 80 can be otherwise a power cord for connecting to a power socket. Although not shown, it is understood the power allocation unit 80 can be otherwise arranged in the light-guiding tool shank 1001 instead of the handle unit 60.

Although not shown, the handle unit 60 and the shank body 10 can be integrally formed with each other.

The use of the light-emitting fastening tool 3001 to fix the fastener 2 is described below by referring to FIG. 6. As shown in FIG. 6, the fastener fixing head 30 of the light-emitting fastening tool 3001 is configured as a screwdriver's head, and the fastener 2 is a screw.

When a user tries to fix a fastener 2 to a predetermined fastener fixing position 1a on an object 1 while the working environment is relatively dark, the user may use the light-emitting fastening tool 3001 to quickly sort out the desired fastener 2 and align the fastener 2 with the predetermined fastener fixing position 1a.

After sorting out the desired fastener 2, the user may, in the dark working environment, utilize the light beam L emitted by the light-emitting element 70 in the light-guiding fastening tool 3001 to aligning the fastener 2 with the predetermined fastener fixing position 1a on the object 1 and then drives the fastener 2 into the object 1.

In brief, with the light-emitting fastening tool 3001 of the present invention that includes the light-guiding tool shank 1001 and the light-emitting element 70, the user is enabled to sort out a desired fastener 2 and align the fastener 2 with a predetermined fastening fixing position 1a in the dark working environment or in the night and to fix the fastener 2 in increased working efficiency. In the case the light-emitting fastening tool 3001 is used on a production line, it also enables quick alignment of a fastener with a predetermined fastener fixing position to upgrade the working efficiency.

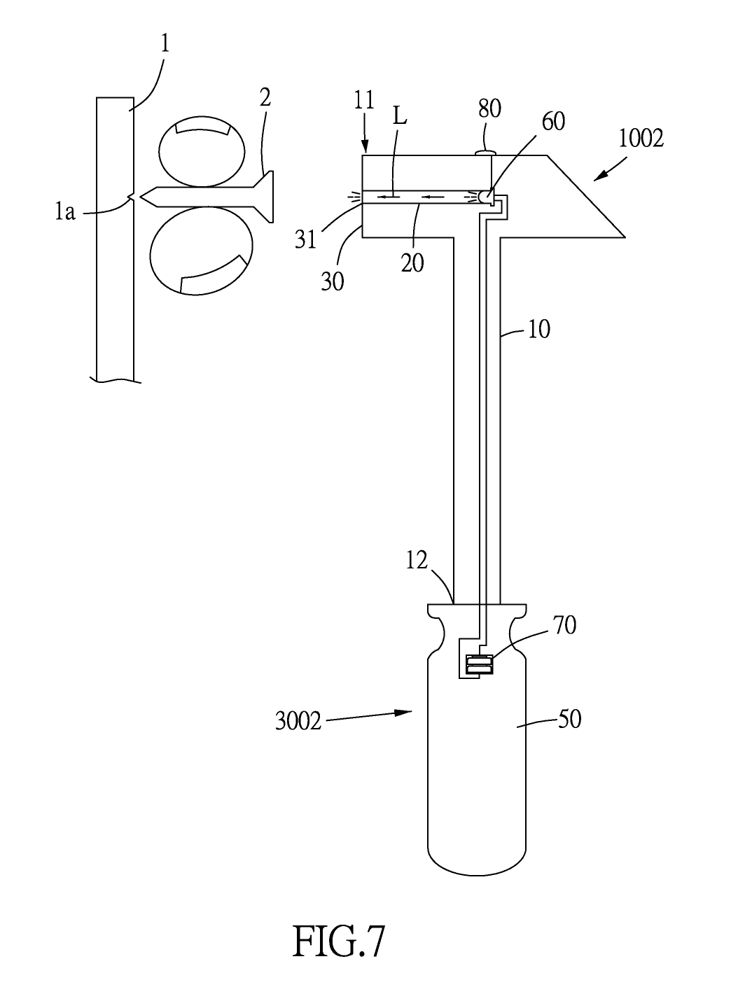

FIG. 7 is a sectional view showing the structure and the use of a second embodiment of the light-emitting fastening tool according to the present invention, which is generally denoted by reference numeral 3002 herein. As shown, the light-emitting fastening tool 3002 is generally similar to the light-emitting fastening tool 3001 in design, except that it includes the above-described light-guiding tool shank 1002.

The light-emitting fastening tool 3002 is different from the light-emitting fastening tool 3001 in further including a switch unit 90 that is arranged on the shank body 10 and electrically connected to the light-emitting element 70. With these arrangements, the user can control the time point for the light-emitting element 70 to emit light. More specifically, when the light-emitting fastening tool 3002 is not used in a dark working environment, the user may turn off the light-emitting element 70 via the switch unit 90 to achieve the purpose of power saving. It is understood the switch unit 90 is not necessarily arranged on the shank body 10 but can be arranged on any other suitable position on the light-emitting fastening tool 3002.

As can be seen in FIG. 7, the fastener fixing head 30 of the light-emitting fastening tool 3002 is configured as a hammer's head, and the fastener 2 is a nail. When the user tries to fix the fastener 2 to a predetermined fastener fixing position 1a on an object 1 while the working environment is relatively dark, the user may use the light-emitting fastening tool 3002 to quickly sort out the desired fastener 2 and locate the predetermined fastener fixing position 1a.

After sorting out the desired fastener 2, the user may utilize the light beam L emitted by the light-emitting element 70 in the light-guiding fastening tool 3002 to aligning the fastener 2 with the predetermined fastener fixing position 1a on the object 1 in the dark working environment, and then drives the fastener 2 into the object 1.

In brief, with the light-emitting fastening tool 3002 of the present invention that includes the light-emitting element 70, the user is enabled to sort out a desired fastener 2 and align the fastener 2 with the predetermined fastening fixing position 1a in the dark working environment to fix the fastener in increased working efficiency.

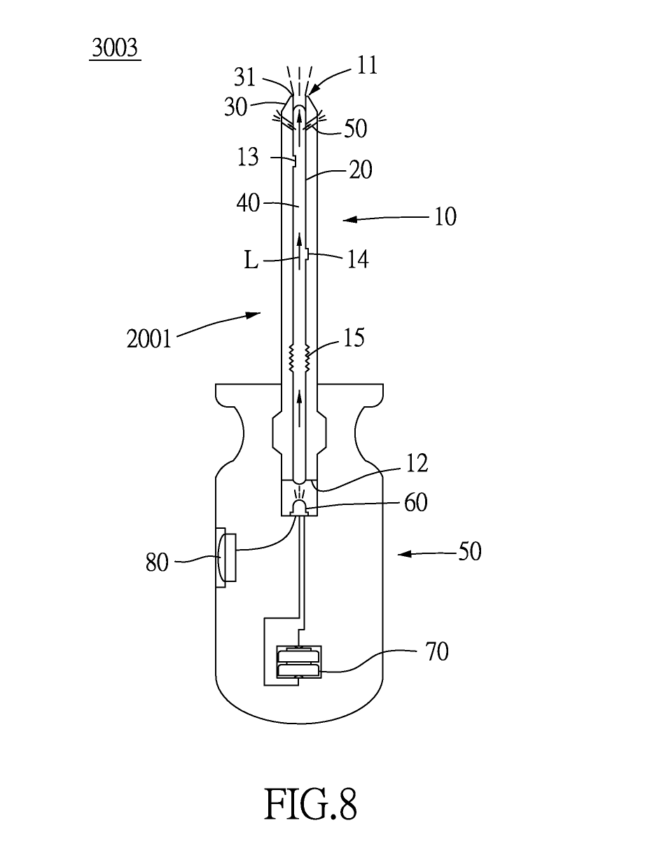

FIG. 8 is a sectional view showing a third embodiment of the light-emitting fastening tool according to the present invention, which is generally denoted by reference numeral 3003 herein. As shown, the light-emitting fastening tool 3003 includes a handle unit 60, the above-described high light-guiding tool shank 2001, a light-emitting element 70, a power allocation unit 80, and a switch unit 90.

The shank body 10 of the high light-guiding tool shank 2001 is connected at the second end 12 to the handle unit 60. More specifically, the shank body 10 is inserted into the handle unit 60.

The light-emitting element 70 is disposed in the handle unit 60 and is capable of emitting a light beam L, which sequentially passes through the light-guiding portion 20 and the light projecting hole 31. According to the present invention, the light-emitting element 70 is preferable a light-emitting diode (LED).

The power allocation unit 80 is arranged in the handle unit 60 and is electrically connected to the light-emitting element 70 for supplying power to the latter. The power allocation unit 80 can be a battery holder, into which a user may mount batteries or rechargeable batteries prior to or after using the light-emitting fastening tool 3003, depending on actual need in use. Alternatively, the power allocation unit 80 can be a solar battery that converts solar energy into electric energy and supplies the latter to the light-emitting element 70. Further, the power allocation unit 80 can be otherwise a power cord for connecting to a power socket. Although not shown, it is understood the power allocation unit 80 can be otherwise arranged in the high light-guiding tool shank 2001 instead of the handle unit 60.

The switch unit 90 is arranged on the handle unit 60 and electrically connected to the light-emitting element 70. With these arrangements, the user can control the time point for the light-emitting element 70 to emit light. More specifically, when the light-emitting fastening tool 3003 is not used in a dark working environment, the user may turn off the light-emitting element 70 via the switch unit 90 to achieve the purpose of power saving.

With the light-guiding body 40, the light beam L emitted by the light-emitting element 70 can be transmitted to an environment outside the light projecting hole 31. Further, with the light-guiding hole 50, the light beam L can be projected into surrounding working environment to illuminate the same.

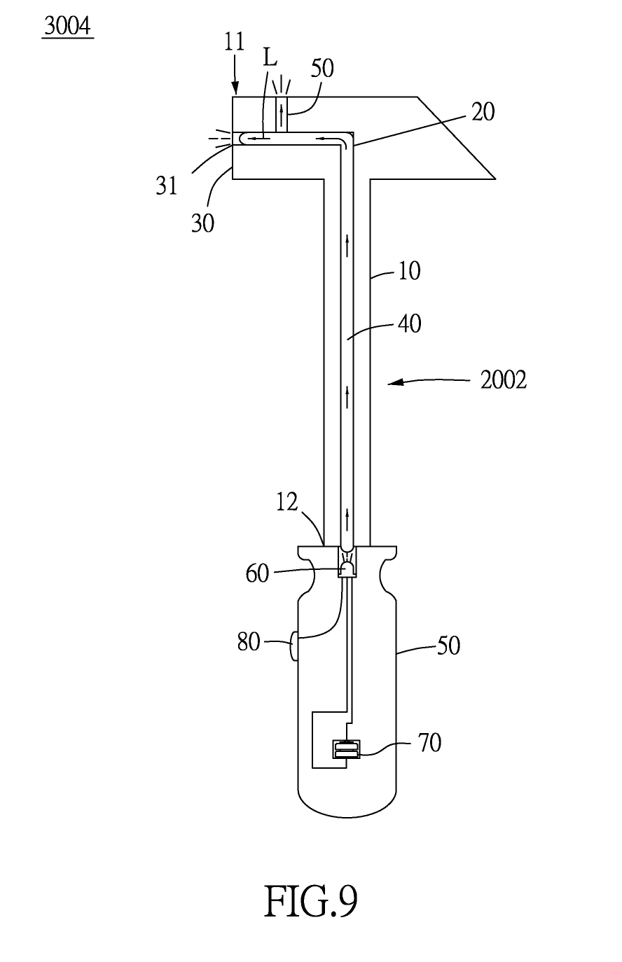

Please refer to FIG. 9 that is a sectional view showing a fourth embodiment of the light-emitting fastening tool according to the present invention, which is generally denoted by reference numeral 3004 herein. As shown, the light-emitting fastening tool 3004 is generally similar to the light-emitting fastening tool 3003 in design, except that it includes the above-described high light-guiding tool shank 2002.

In the light-emitting fastening tool 3004, since the shank body 10 is a bent bar, the light-guiding portion 20 is a bent passage and the light-guiding body 40 has a shape corresponding to that of the light-guiding portion 20, the light-guiding body 40 in the light-emitting fastening tool 3004 is a bent light-guiding body. With the bent light-guiding body 40, the light beam L emitted by the light-emitting element 70 can be transmitted to an environment outside the light projecting hole 31. And, with the light-guiding hole 50, the light beam L can be projected into surrounding working environment to illuminate the same.

In brief, with the light-emitting fastening tool 3003, 3004 of the present invention that includes the high light-guiding tool shank 2001, 2002 and the light-emitting element 70, the user is enabled to sort out the desired fastener 2 and align the fastener 2 with the predetermined fastening fixing position 1a in the dark working environment or in the night to thereby fix the fastener 2 in increased working efficiency. And, the light-emitting fastening tool can be a screwdriver or a hammer. In the case the light-emitting fastening tool 3003, 3004 is used on a production line, it also enables quick alignment of the fastener 2 with the predetermined fastener fixing position 1a to upgrade the working efficiency.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A light-guiding tool shank for forming a part of a light-emitting fastening tool, comprising:
a shank body having a first end and an opposite second end;
a light-guiding portion being formed in the shank body to locate between the first and the second end of the shank body; and
a fastener fixing head being located at the first end of the shank body and defining a light projecting hole; and the light projecting hole being communicable with the light-guiding portion.

2. The light-guiding tool shank as claimed in claim 1, wherein the shank body is selected from the group consisting if a straight bar and a bent bar.

3. The light-guiding tool shank as claimed in claim 1, wherein the light-guiding portion is communicable with the first end and the second end.

4. The light-guiding tool shank as claimed in claim 1, further comprising at least one light-guiding hole; and the light-guiding hole being extended through a peripheral wall of the shank body and communicable with the light-guiding portion.

5. The light-guiding tool shank as claimed in claim 1, wherein the fastener fixing head is selected from the group consisting of a screwdriver's head and a hammer's head.

6. The light-guiding tool shank as claimed in claim 5, wherein the fastener fixing head configured as the screwdriver's head is selected from the group consisting of a slot head, a cross-recess head, a hexagon head, a star head, and a combined star and slot head.

7. A high light-guiding tool shank, comprising:
a light-guiding tool shank as claimed in claim 1; and
a light-guiding body being disposed in the light-guiding portion of the light-guiding tool shank.

8. The high light-guiding tool shank as claimed in claim 7, wherein the shank body of the light-guiding tool shank is provided on an inner surface of a peripheral wall thereof with at least one of a plurality of protrusions, a plurality of recesses, a plurality of screw threads and a plurality of embossed areas; and the protrusions, the recesses, the screw threads and the embossed areas being located within the light-guiding portion for holding the light-guiding body in place in the shank body.

9. The high light-guiding tool shank as claimed in claim 7, wherein the light-guiding body has a shape corresponding to that of the light-guiding portion of the light-guiding tool shank.

10. The high light-guiding tool shank as claimed in claim 7, wherein the light-guiding body is made of a material selected from the group consisting of an optic fiber, a fiber, plastics, glass, quartz, acrylic, rubber and silicone.

11. The high light-guiding tool shank as claimed in claim 7, wherein the light-guiding body is held in the light-guiding portion in a way selected from the group consisting of hooking, gluing, expansion fitting, snap fitting, thermal bonding, and insert molding.

12. A light-emitting fastening tool for fixing a fastener, comprising:
a handle unit;
a light-guiding tool shank as claimed in claim 1, of which the shank body being connected at the second end to the handle unit;
a light-emitting element being disposed in one of the light-guiding portion of the light-guiding tool shank and the handle unit for emitting a light beam, and the light beam sequentially passing through the light-guiding portion and the light projecting hole; and
a power allocation unit being arranged in one of the handle unit and the light-guiding tool shank and being electrically connected to the light-emitting element.

13. The light-emitting fastening tool as claimed in claim 12, further comprising a switch unit; and the switch unit being arranged on one of handle unit and the shank body, and being electrically connected to the light-emitting element.

14. The light-emitting fastening tool as claimed in claim 12, wherein the shank body is inserted into the handle unit.

15. The light-emitting fastening tool as claimed in claim 12, wherein the light-emitting element is a light-emitting diode (LED).

16. The light-emitting fastening tool as claimed in claim 12, wherein the handle unit and the shank body are integrally formed with each other.
